(19) United States
(12) Patent Application Publication
(10) Pub. No.: US 2012/0224568 A1
(43) Pub. Date: Sep. 6, 2012

(54) METHOD AND APPARATUS FOR SYNCHRONIZING NODE TRANSMISSIONS IN A NETWORK

(75) Inventors: Martino M. Freda, Laval (CA); Alpaslan Demir, East Meadow, NY (US); Jean-Louis Gauvreau, La Prairie (CA)

(73) Assignee: INTERDIGITAL PATENT HOLDINGS, INC., Wilmington, DE (US)

(21) Appl. No.: 13/407,103

(22) Filed: Feb. 28, 2012

Related U.S. Application Data
(60) Provisional application No. 61/448,458, filed on Mar. 2, 2011.

(51) Int. Cl. H04W 56/00; H04W 74/08

(52) U.S. Cl. 370/338

(57) ABSTRACT

A method and apparatus are described for synchronizing a network. A plurality of existing nodes in the network may transmit beacons in accordance with a round-robin scheduling sequence. A new joining node may receive a beacon from a specific one of the existing nodes during a beacon interval, and transmit a join beacon frame during the beacon interval after waiting a random period of time. The specific existing node may receive the join beacon frame and transmit a notification to the other existing nodes in the network indicating that a new node is joining the network. Alternatively, the existing nodes may transmit a primary synchronization sequence (PSS) and a secondary synchronization sequence (SSS). After a new node receives the PSS and SSS from a specific one of the existing nodes, the new node may generate a random access channel (RACH) preamble indicating that it desires to join the network.

### CROSS REFERENCE TO RELATED APPLICATIONS

This application claims the benefit of Provisional Application Ser. No. 61/448,458 filed Mar. 2, 2011, the contents of which is incorporated by reference herein.

### BACKGROUND

An IEEE 802.11 beacon frame may be used to discover nodes, (e.g., wireless transmit/receive units (WTRUs), mobile stations, stations (STAs)), in the network and provide synchronization to implement power saving features and for frequency hopping. In an IEEE 802.11 infrastructure mode, an access point (AP) may send a beacon to all nodes that are associated with the AP. The beacon may carry a timestamp value indicating the value of a local clock of the AP. After receiving the beacon, each node may use the timestamp value to update its local clock. This process may enable synchronization among the nodes.

In an IEEE 802.11 ad hoc mode of operation, communication may be enabled by the establishment of an independent basic service set (IBSS). Since there is no AP used in the ad hoc mode, a distributed algorithm may be used for beacon transmission and synchronization. In a distributed algorithm, beacons may be transmitted periodically, (as in an infrastructure mode), where each node may have an equal probability of being selected to transmit the beacon for all other nodes in the network.

The distributed beacon transmission algorithm present in IEEE 802.11 ad hoc mode presents several problems or shortcomings. Firstly, the potential of beacon collision is possible, whereby the random delay interval chosen by two or more nodes may be close enough that these nodes decide to transmit the beacon simultaneously. Since the beacon, unlike regular frames in IEEE 802.11, is not acknowledged, this scenario may lead to a loss of the beacon for that beacon interval. In addition, since selection of the node that transmits the beacon at any given beacon interval is purely random, the possibility of a fast node losing synchronization exists and more so as the number of nodes in the network increases. In particular, a node whose clock is faster than the other nodes may not get to transmit a beacon for a large period of time if the beacon selection procedure proves unfavorable to it. This period of time may be large enough that the node loses synchronization with the rest of the network, forcing it to restart its discovery procedure and re-join the IBSS. The above problems become magnified when considering a multi-hop network, given that the existing scheme was designed for a single hop or fully connected network. Since there is an even greater chance for loss of synchronization, scenarios may occur where two partially connected subnetworks may enter a different timing of awake (i.e., activated) and doze (i.e., deactivated) states. This may make network routing inefficient and difficult and, in some cases, make communication between two nodes impossible.

Furthermore, existing procedures used to avoid beacon collision are not scalable to large networks because target beacon transmission time (TBTT) and beacon timing of each node is sent in the network. In addition, there is no consideration of race conditions that may occur when multiple hidden nodes may try to independently modify their TBTT. Finally, in addition to performing a beacon synchronization procedure, avoidance of partially connected subnetworks may require additional messaging, and power efficiency of the beacon transmission times across the entire network may not be a factor built into the procedure.

### SUMMARY

A method and apparatus are described for synchronizing a network. A plurality of existing nodes in the network may transmit beacons in accordance with a round-robin scheduling sequence. A new joining node may receive a beacon from a specific one of the existing nodes during a beacon interval, and transmit a join beacon frame during the beacon interval after waiting a random period of time. The specific existing node may receive the join beacon frame and transmit a notification to the other existing nodes in the network indicating that a new node is joining the network. Alternatively, the existing nodes may transmit a primary synchronization sequence (PSS) and a secondary synchronization sequence (SSS). After a new node receives the PSS and SSS from a specific one of the existing nodes, the new node may generate a random access channel (RACH) preamble indicating that it desires to join the network.

### BRIEF DESCRIPTION OF THE DRAWINGS

A more detailed understanding may be had from the following description, given by way of example in conjunction with the accompanying drawings wherein:

FIG. 1A shows an example communications system in which one or more disclosed embodiments may be implemented;

FIG. 1B shows an example wireless transmit/receive unit (WTRU) that may be used within the communications system shown in FIG. 1A;

FIG. 1C shows an example radio access network and an example core network that may be used within the communications system shown in FIG. 1A;

FIG. 2 shows example beacon intervals and announcement traffic indication message (ATIM) windows;

FIG. 3 shows an example of a ring of nodes operating during a firing period;

FIG. 4A shows an example DESYNC ring including existing nodes that form a fully connected network, and a new joining node;

FIGS. 4B and 4C show the example DESYNC ring of FIG. 4A after the nodes change their firing times;

FIG. 5A shows an example DESYNC ring including existing nodes that form a non-fully connected network, and a new joining node;

FIGS. 5B and 5C show the example DESYNC ring of FIG. 5A after the nodes change their firing times;

FIG. 6A shows an example DESYNC ring including existing nodes of a fully connected network;

FIGS. 6B and 6C show the example DESYNC ring of FIG. 6A after some of the nodes left the DESYNC ring and some of the remaining nodes changed their firing times;

FIG. 7 shows an example of the steady-state beacon transmission between three nodes of a fully connected network;

FIG. 8 shows an example of a join beacon frame transmission when a node is joining an ad hoc network;

FIG. 9 shows an example of a joining procedure involved when a node joins the network and no forwarding of a station join announcement message (SJAM) is required;

FIG. 10 shows an example of a joining procedure involved when a node joins the network and forwarding of an SJAM is required;

FIGS. 11A and 11B shows message formats for reporting nodes joining and leaving an ad hoc network; and

FIG. 12 shows an example block diagram of a node.

### DETAILED DESCRIPTION

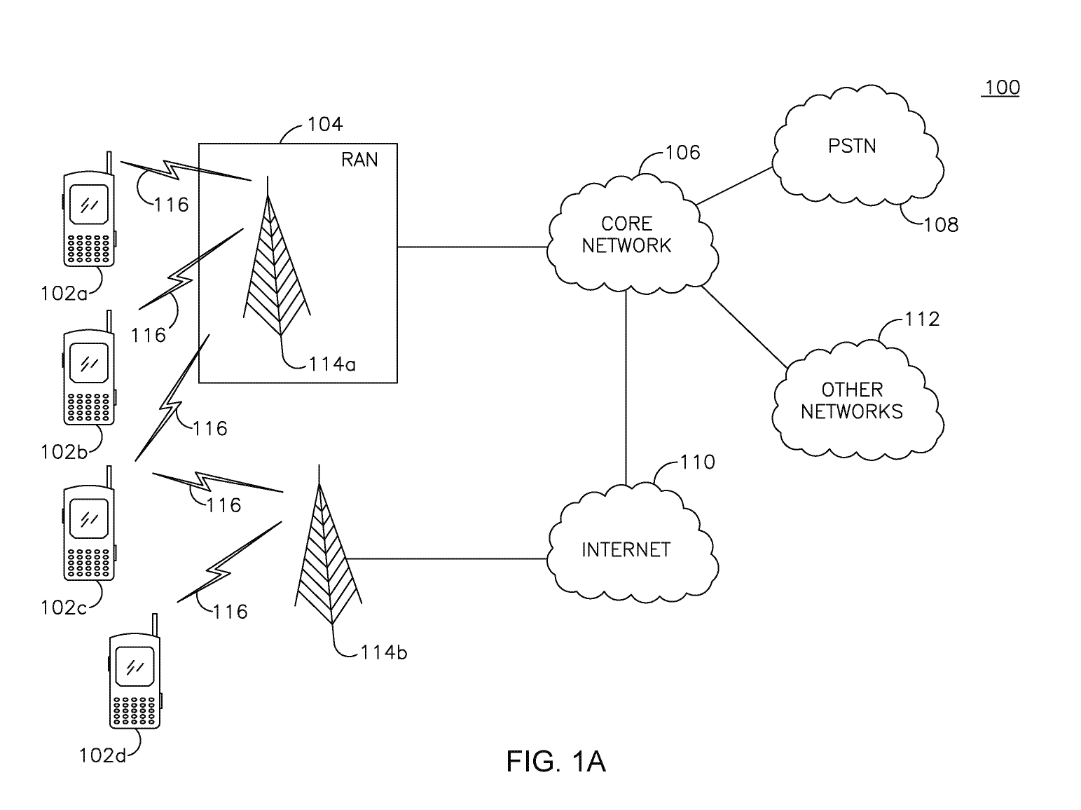

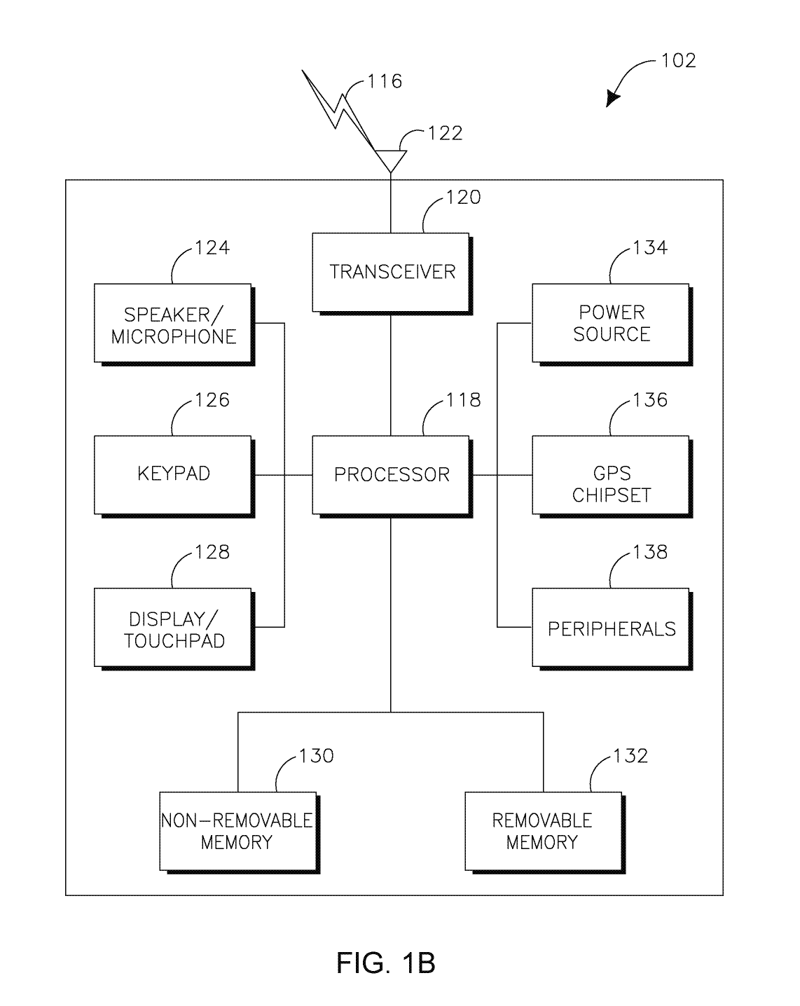

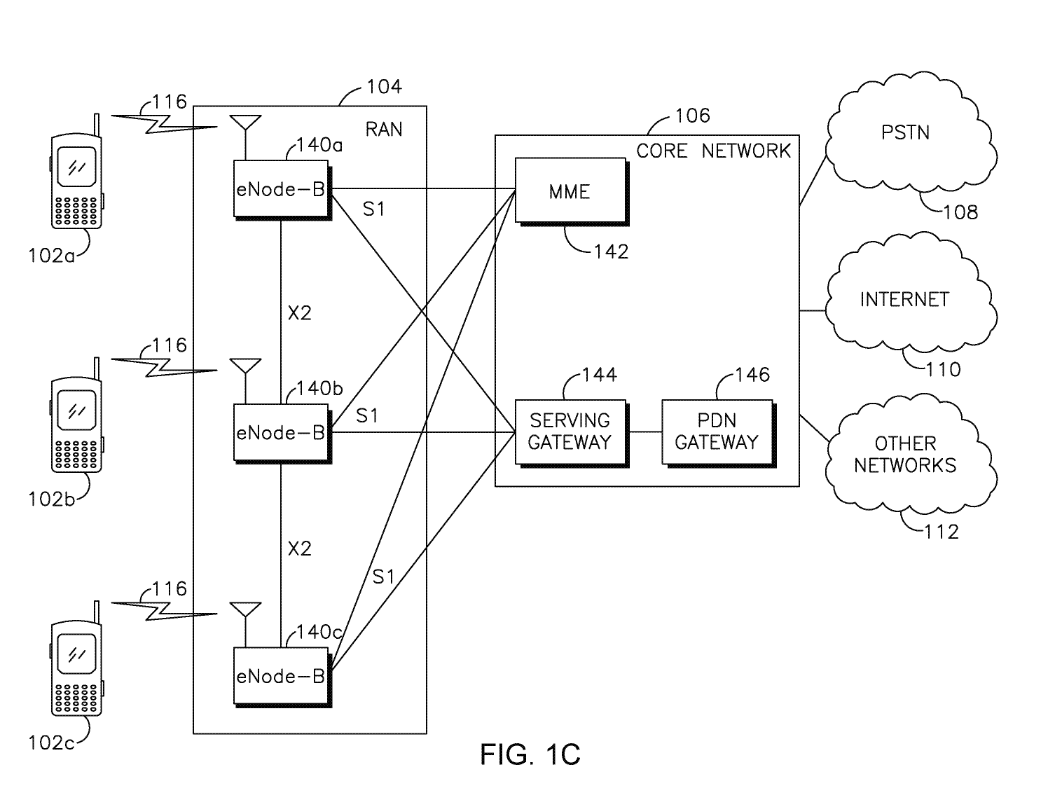

FIG. 1A shows an example communications system 100 in which one or more disclosed embodiments may be implemented. The communications system 100 may be a multiple access system that provides content, such as voice, data, video, messaging, broadcast, and the like, to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include WTRUs 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a station (STA), a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an evolved Node-B (eNB), a Home Node-B (HNB), a Home eNB (HeNB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link, (e.g., radio frequency (RF), microwave, infrared (IR), ultraviolet (UV), visible light, and the like). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as universal mobile telecommunications system (UMTS) terrestrial radio access (UTRA), which may establish the air interface 116 using wideband CDMA (WCDMA). WCDMA may include communication protocols such as high-speed packet access (HSPA) and/or evolved HSPA (HSPA+). HSPA may include high-speed downlink packet access (HSDPA) and/or high-speed uplink packet access (HSUPA).

In another embodiment, the base station 114a and the WTRUs 102a, 102b, 102c may implement a radio technology such as evolved UTRA (E-UTRA), which may establish the air interface 116 using long term evolution (LTE) and/or LTE-Advanced (LTE-A).

In other embodiments, the base station 114a and the WTRUs 102a, 102b, 102c may implement radio technologies such as IEEE 802.16 (i.e., worldwide interoperability for microwave access (WiMAX)), CDMA2000, CDMA2000 1X, CDMA2000 evolution-data optimized (EV-DO), Interim Standard 2000 (IS-2000), Interim Standard 95 (IS-95), Interim Standard 856 (IS-856), global system for mobile communications (GSM), enhanced data rates for GSM evolution (EDGE), GSM/EDGE RAN (GERAN), and the like.

The base station 114b in FIG. 1A may be a wireless router, HNB, HeNB, or AP, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT, (e.g., WCDMA, CDMA2000, GSM, LTE, LTE-A, and the like), to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over Internet protocol (VoIP) services to one or more of the WTRUs 102a, 102b, 102c, 102d. For example, the core network 106 may provide call control, billing services, mobile location-based services, pre-paid calling, Internet connectivity, video distribution, and the like, and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the Internet protocol (IP) in the TCP/IP suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B shows an example WTRU 102 that may be used within the communications system 100 shown in FIG. 1A. As shown in FIG. 1B, the WTRU 102 may include a processor 118, a transceiver 120, a transmit/receive element, (e.g., an antenna), 122, a speaker/microphone 124, a keypad 126, a display/touchpad 128, a non-removable memory 130, a removable memory 132, a power source 134, a global positioning system (GPS) chipset 136, and peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a microprocessor, one or more microprocessors in association with a DSP core, a controller, a microcontroller, an application specific integrated circuit (ASIC), a field programmable gate array (FPGA) circuit, an integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. The transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122, (e.g., multiple antennas), for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station, (e.g., base stations 114a, 114b), and/or determine its location based on the timing of the signals being received from two or more nearby base stations. The WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C shows an example RAN 104 and an example core network 106 that may be used within the communications system 100 shown in FIG. 1A. As noted above, the RAN 104 may employ an E-UTRA radio technology to communicate with the WTRUs 102a, 102b, 102c over the air interface 116. The RAN 104 may also be in communication with the core network 106.

The RAN 104 may include eNBs 140a, 140b, 140c, though it will be appreciated that the RAN 104 may include any number of eNBs while remaining consistent with an embodiment. The eNBs 140a, 140b, 140c may each include one or more transceivers for communicating with the WTRUs 102a, 102b, 102c over the air interface 116. In one embodiment, the eNBs 140a, 140b, 140c may implement MIMO technology. Thus, the eNB 140a, for example, may use multiple antennas to transmit wireless signals to, and receive wireless signals from, the WTRU 102a.

Each of the eNBs 140a, 140b, 140c may be associated with a particular cell (not shown) and may be configured to handle radio resource management decisions, handover decisions, scheduling of users in the uplink and/or downlink, and the like. As shown in FIG. 1C, the eNBs 140a, 140b, 140c may communicate with one another over an X2 interface.

The core network 106 shown in FIG. 1C may include a mobility management entity (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNBs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNBs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNB handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway, (e.g., an IP multimedia subsystem (IMS) server), that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

In an IEEE 802.11 ad hoc mode, each of a plurality of nodes in a network may maintain a timing synchronization function (TSF) timer or clock that counts in increments of microseconds (modulus 2̂64). The nodes may listen and expect to receive beacons at a rate defined by a beacon period parameter, which may be decided by an initial node that created the IBSS and defined the length of the beacon interval. At the beginning of each beacon interval, those nodes that were turned off for power savings may wake up, moving from a “doze” state, (where they do not transmit or receive any frames), to an “awake” state.

When in the awake state, each node may suspend the decrementing of a backoff timer for pending non-beacon transmissions at the beginning of the beacon interval. The node may initiate a random delay timer at the beginning of the beacon interval to establish a random delay interval for transmitting a beacon frame that is uniformly distributed in the range between 0 and 2×CWₘᵢₙ, where CWₘᵢₙ is the minimum value of the contention window (CW). If a beacon arrives before the random delay timer expires, the node may stop the random delay timer, cancel the pending beacon transmission and resume the backoff timer that it may have previously cancelled. If the random delay timer expires and no beacon frame is yet received, the node may transmit the beacon frame.

In the above procedure, each node may be equally likely to transmit the beacon. The node that transmits the beacon may set the value of the beacon timestamp to its current TSF timer. The node receiving the beacon may compare the timestamp with its own TSF timer. If the timestamp is larger (later) than its own TSF timer, the node may set its TSF timer to the value of the timestamp. On the other hand, if the value of the timestamp is smaller (earlier) than the node's own TSF timer, the node may keep its TSF timer as is. As a result, all of the nodes may synchronize their TSF timer to the quickest TSF timer in the IBSS.

Power saving in an IEEE 802.11 ad hoc mode may be achieved through use of an announcement traffic indication message (ATIM). Following the transmission of the beacon, all of the nodes may remain in the awake state for an interval of time referred to as the ATIM window. During the ATIM window, any node having a multicast or unicast data frame that is ready to transmit may announce this to a receiving node by sending an ATIM frame. Since all of the nodes are awake, a node that receives an ATIM frame that is addressed to it expects to receive a data frame in the current beacon interval. As a result, the node that is to transmit the frame, the receiving node and the node that transmitted the beacon prior to the current ATIM window remain in the awake state during the current beacon interval, while the remaining nodes may move to a doze state for the current beacon interval. The same process, (beginning with the transmission of the beacon at the start of the next beacon interval), may then be repeated again at the next beacon interval.

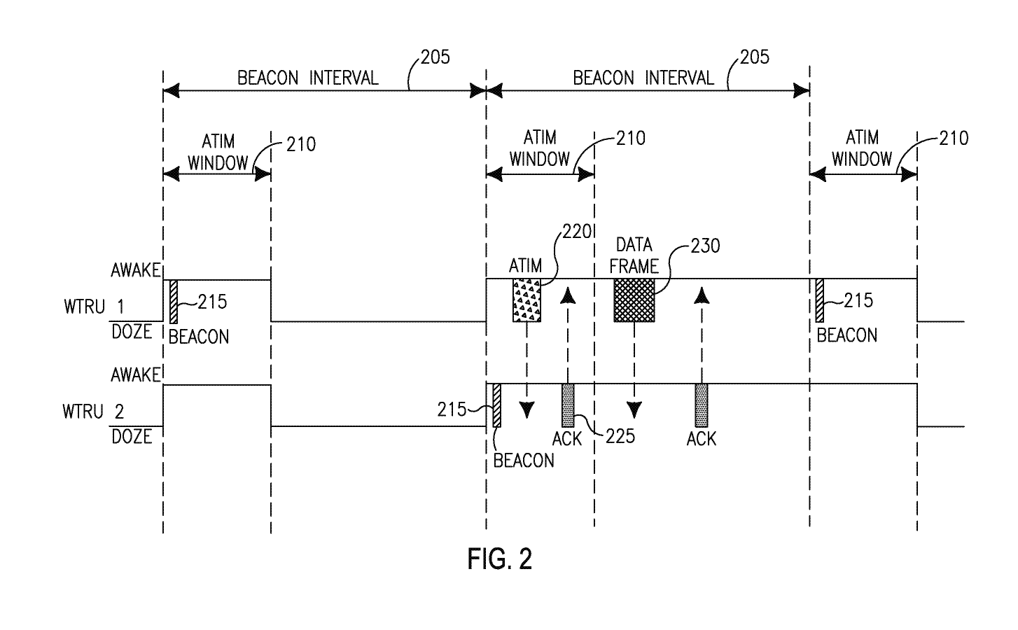

FIG. 2 shows example beacon intervals 205 and ATIM windows 210. During each ATIM window 210, only beacon frames 215, ATIM frames 220, and positive acknowledgement (ACK) frames 225 may be transmitted by nodes (e.g., WTRUs 1 and 2). Data frames 230 that were announced during the ATIM window 210 may be transmitted outside the ATIM windows 210 using regular carrier sense multiple access with collision avoidance (CSMA/CA).

Beacon collision avoidance may be achieved by having each node transmit a beacon timing information element (IE) that contains the TBTT information of all nodes in the network. The nodes may then individually modify their own TBTT to avoid beacon collision with other nodes.

A new timing synchronization method and apparatus for IEEE 802.11 ad hoc nodes is described herein. A multi-hop desynchronization (DESYNC) algorithm may be implemented to synchronize IEEE 802.11 ad hoc nodes when mobile hosts are not fully connected. Synchronization of cellular networks performing node-to-node communication is also considered.

DESYNC is a primitive for ensuring that nodes in a sensor network interleave periodic events so that they occur in an evenly spaced fashion in time. DESYNC may be used for the scheduling of node “sleep” cycles and creating a fairly scheduled time division multiple access (TDMA) system. The traditional DESYNC algorithm may assume a single hop network where all nodes in a network are capable of monitoring each other. The areas of cognitive radio and self-organized networks involve the hidden-node problem and may be multi-hop networks. Although a multi-hop DESYNC algorithm is described herein, the DESYNC algorithm may require an initial communication stage and, therefore, may not be suited to the application of network node discovery and synchronization. In addition, a solution to the multi-hop DESYNC problem has been proposed that assumes application of DESYNC on a constrained graph. This implies that the firings of each node are forwarded to all other nodes in the network, which would result in synchronization traffic that would increase as the number of nodes in the network increases.

A method and apparatus for extending the DESYNC algorithm to a multi-hop network is disclosed. According to this method, it is not assumed that each node in the network is capable of monitoring the beacons of all other nodes. Here, more than one hop may be achieved without increasing the messaging overhead as the size of the network increases. This in itself may solve many synchronization problems in the area of networking and self-organized networks. The multi-hop DESYNC algorithm may solve the synchronization problem in an IEEE 802.11 ad hoc mode. In particular, the ATIM window may be used to exchange messaging required for the multi-hop DESYNC algorithm's proper functioning. By achieving DESYNC, each node in the network may periodically transmit the beacon, thus ensuring no loss of synchronization for a fast node and no potential for beacon collision. In addition, since the multi-hop DESYNC algorithm may operate in a multi-hop scenario, the synchronization algorithm may not be limited to a fully connected network. Since the concepts of the beacon interval and ATIM windows are maintained, the changes to the IEEE 802.11 ad hoc mode to implement this method of synchronization are minimal.

Despite the application of the multi-hop DESYNC algorithm described herein to the scenario of synchronization in IEEE 802.11 ad hoc mode, the multi-hop DESYNC algorithm may have applications in other areas where different entities may obtain synchronization of their operations in a fair and distributed way, (as with traditional DESYNC).

It is assumed that the entities that wish to achieve synchronization are a set of nodes that transmit a distinct signal periodically with a period T. The transmission of this signal may be referred to as a firing event. In the traditional (single hop) DESYNC algorithm, the nodes may coordinate their firings in such a way as to achieve a state of equilibrium where each of their firings is uniformly distributed over a time period T, referred to as the firing period. The organization of the firing events of the nodes over the firing period may be considered to be in the form of a ring or equally spaced nodes. Equilibrium may be achieved from an initial non-equilibrium state, (or by the incremental joining of new nodes into the firing scheme), by each node adjusting its firing to occur at the midpoint between its previous and subsequent node. This assumes that each node may monitor the nodes that fire immediately before and after it, (i.e., there is a fully connected network with no hidden-node problem).

In the case of a multi-hop network or a non-fully connected network, it may be assumed that a node desiring to join a network “hears” (i.e., detects) only a subset of the firings from the other nodes. In order to ensure that the network achieves the same state of equilibrium, each node may send a timing parameter, a hop number, and a network identity (ID), along with its firing. The timing parameter may represent the expected amount of time between a node's firing event and the firing event of the next node in the ring, (which in the case of a single-node ring, is the firing period T itself). The timing parameter may be an absolute time value (in seconds), or it may be in terms of the number of time intervals (slots) of fixed duration.

When a node desires to join a network (i.e., DESYNC ring) in which it detects one or more firings from other nodes, it may use the timing parameter value to determine the actual midpoint between a node for which it detects a firing and the next node in the ring, (which may or may not be detected by the node trying to join the network). The midpoint may occur at a value equal to half of an advertised time difference (ATD) value.

Under static conditions, each node in a network may transmit its ATD and hop number with its firing. The ATD of each node may be equal when DESYNC has been achieved. When a node joins or leaves the network, the ATD of all of the nodes in the network may be updated based on the change in the DESYNC state.

The hop number and the network ID may be used to coordinate the maximum number of nodes that may form a single DESYNC ring before a new DESYNC ring is formed with a different timing base. In particular, for a multi-hop network, a node may only interfere with its second order neighbors. As a result, the firing sequence or timing of nodes may be coordinated between nodes and their first and second order neighbors. Higher order neighbor transmissions may not interfere with a node and, therefore, may not be considered in a particular multi-hop network. In order to allow this, a node that is a higher order neighbor may form a new DESYNC ring using a different signaling than the original DESYNC ring. In the case of an actual self-organized network, this may be achieved by changing the frequency on which the beacon is transmitted.

The hop number may represent the closeness, (in terms of number of hops), that a node is to the two nodes that initially formed the network, (i.e., DESYNC ring). By default, the first two nodes that join the network may form a fully-connected network. They may, therefore, assign themselves a hop number of 1. A node that attempts to join a network will assign itself a hop number based on the value of the ATD and the number of nodes it detects over the firing period T. When a node determines that it will join a fully-connected network, it may assign itself a hop number of 1 to indicate that it remains at the same level, (in terms of connectedness), with all the other nodes in the network. A node that only detects a subset of the nodes in the connected base network may assign itself a hop number of 2, and a node that only detects nodes with a hop number of 2 may assign itself a hop number of 3. A node that tries to join a network and detects only nodes with a hop number of 3 may create a new DESYNC ring, as described above.

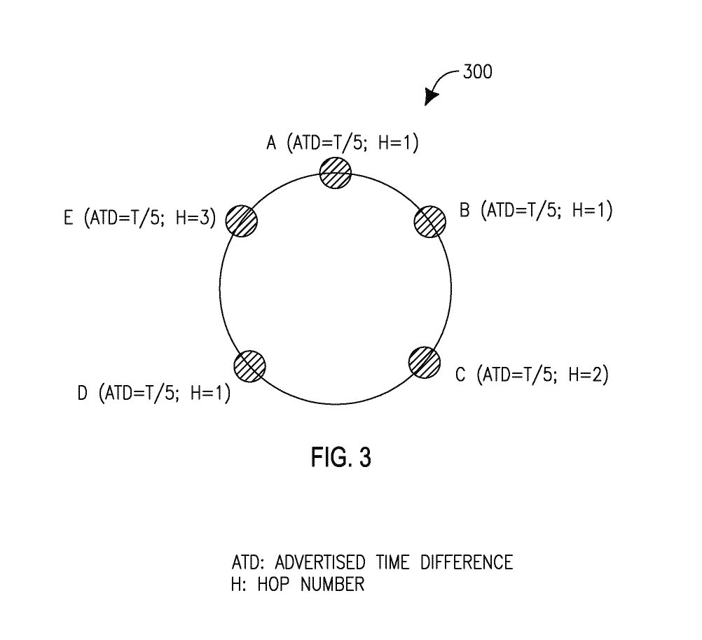

FIG. 3 shows an example of a ring of nodes A-E in a network 300 (i.e., DESYNC ring) operating during a firing period, (once the static equilibrium is reached), and the assigned hop (H) numbers for the nodes A-E.

The multi-hop DESYNC algorithm may be implemented if each of the nodes in the network follow a certain set of procedures. Each procedure may define a set of well-defined rules that each node A-E may adhere to when a certain event takes place. These rules may ensure that DESYNC is achieved despite the fact that the hidden node problem is present. Furthermore, each node A-E may focus on the firing behavior of the node it detects previous to it. This may allow nodes to sleep or perform other work, and also may require a fixed amount of memory for the DESYNC algorithm to be performed, regardless of the number of nodes in the network 300.

In one embodiment, a procedure for a node joining a fully connected network is described herein. A node that desires to join a fully connected network fires at a time of m/2 from one of the nodes in the network it detects, where m is the ATD of the nodes. The joining node may set its own ATD to m/2, its network ID to the network ID of the other nodes in the network, and its hop number to either 1 or 2. If the particular node is able to detect all of the nodes, (based on the ATD and the time between firings), the hop number is set to 1. Otherwise, the hop number is set to 2.

The first node to detect the presence of the joining node may adjust its firing time based on the presence of the joining node by firing at a delay from the previous node that matches what the new ATD should be, and setting its ATD to the new ATD (this node knows the expected ATD because it can detect all of the nodes, including the node that just joined). All subsequent nodes that detect the joining node may also do the same. Any node that does not detect the joining node may adjust its firing time according to the following rule. If its preceding node decreased its ATD but delayed its firing time relative to its previous firing time, the node may fire at a delay that matches the new ATD. If its preceding node decreases its ATD but advanced its firing time relative to its previous firing, the node may assume that there is a hidden-node between its previous node and itself and may fire at a time equal to twice the new ATD. This may account for the presence of the hidden node in the DESYNC ring between it and its preceding node.

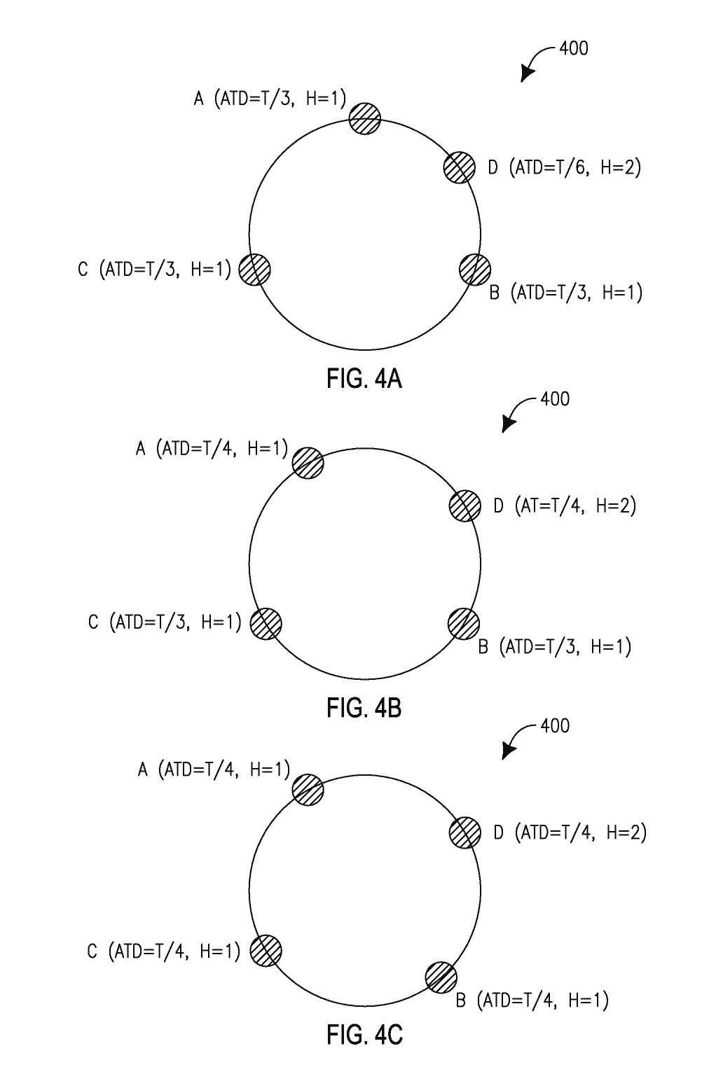

FIGS. 4A, 4B and 4C show an example DESYNC ring including existing nodes (e.g., WTRUs) A, B and C that form a fully connected network 400, and a new joining node D. In the example of FIG. 4A, only node A can hear D (and vice-versa), so node D fires T/6 following the firing of node A and sets its ATD to T/6 (twice the T/3 ATDs of the existing nodes A, B and C). Nodes B and C do not hear node D, but node A acknowledges the arrival of joining node D by changing its ATD to T/4 and advancing its firing time to fire T/4 after node C, as shown in FIG. 4B. Node D changes its ATD to the new network ATD (T/4) advertised by node A and changes its firing accordingly. Node B, seeing that its preceding node (A) has decreased its ATD and fired early, fires after 2×(T/4) following node A. Node C, seeing that Node B has decreased its ATD to T/4 from T/3, and delayed its firing time, also delays its firing time so that it fires T/4 after node B, as shown in FIG. 4C.

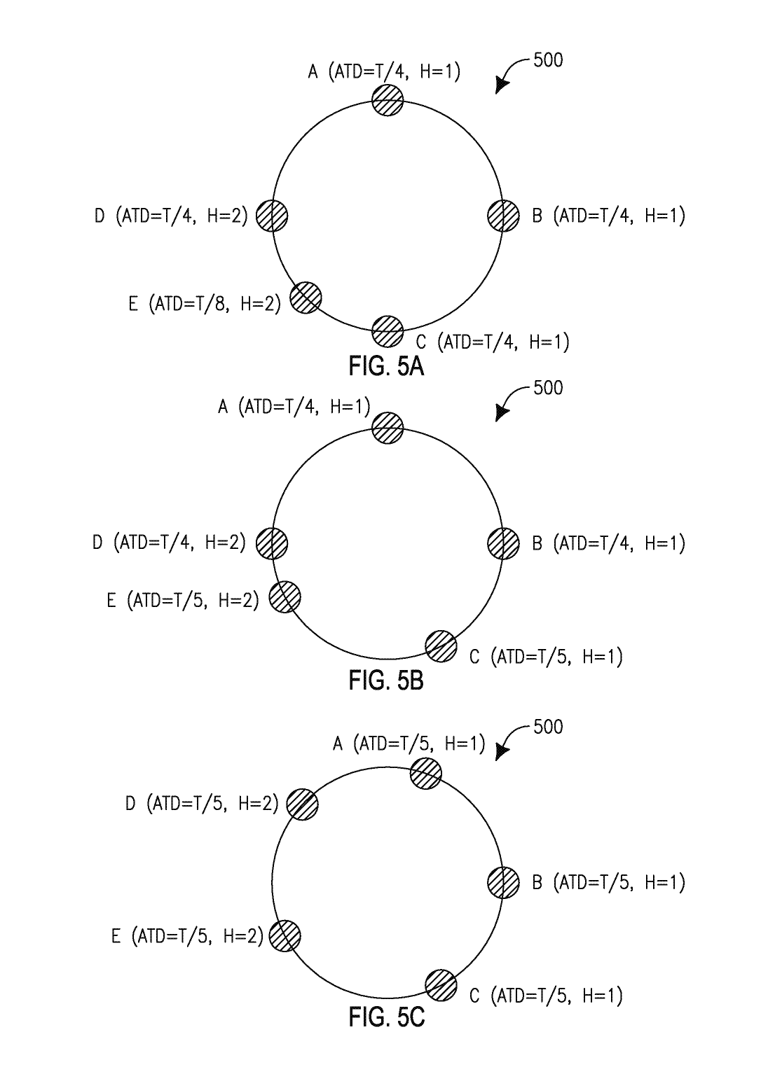

FIG. 5A shows an example DESYNC ring including existing nodes (e.g., WTRUs) A, B, C and D that form a non-fully connected network 500, and a new joining node E. The joining node E may fire first during the largest gap between node firings that it hears. For example, if the new node hears 3 out of 4 nodes currently in the network, it fires during the empty gap where the hidden node is firing, but with a timing of m/2 as usual, (to not collide with the hidden node). The nodes already in the network that are aware of the presence of a hidden node may delegate authority to the node firing just before the joining node E to modify the firing time and ATD. A node may remember the number of hidden nodes between it and its preceding heard neighbor. Whenever a node's preceding heard neighbor reduces its ATD and advances its firing time, the node may increase the number of hidden nodes between it and its preceding heard neighbor by one (to a value x) and fire at x times the new ATD.

In the example illustrated in FIG. 5A, nodes A, B and C may all hear each other, node D may only hear node C, and node E may hear only nodes B and C. Node E may start by firing after node C, (since it is the last in the sequence of nodes that it hears). Nodes D and A do not hear node E, so they do nothing. Node B delegates its authority to node C to make the first change in ATD. Node C changes its ATD and firing, and node D does the same (noticing the presence of a hidden node between itself and node C), as shown in FIG. 5B. As shown in FIG. 5C, node A sets its firing time to 2 times the ATD advertised by node C, as it realizes that there are now two hidden nodes between itself and node C, and node B delays its firing time due to the delay of node A.

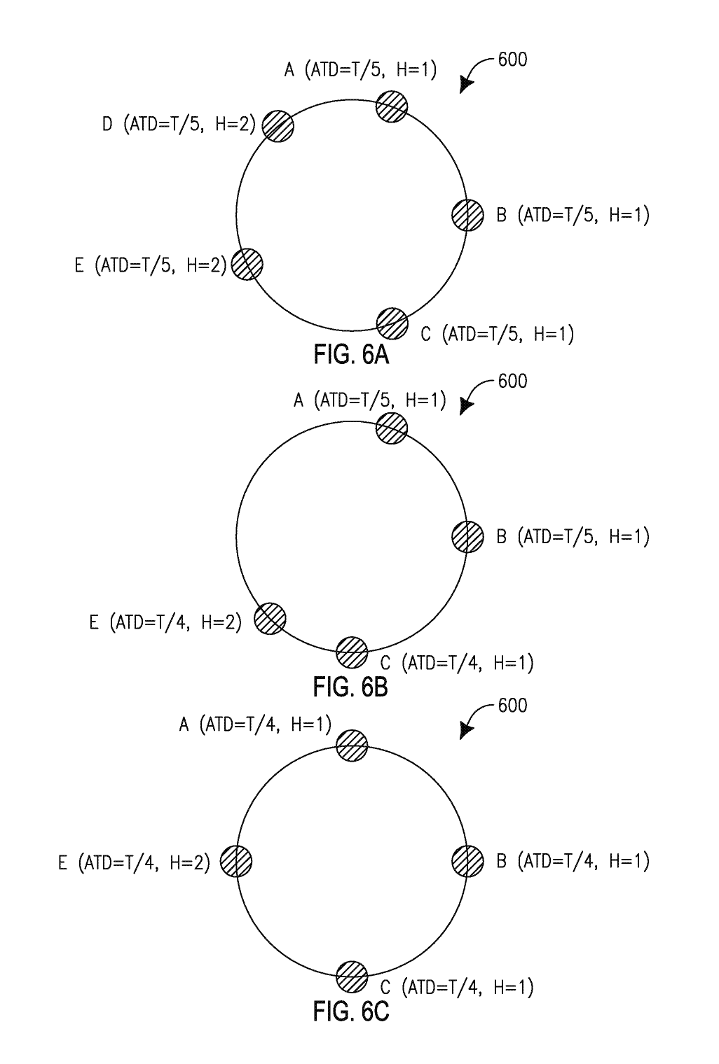

FIG. 6A shows an example DESYNC ring 600 including existing nodes (e.g., WTRUs) A, B, C, D and E of a fully connected network. Since, in this example, all of the nodes A-E have been informed of the ATDs at each step of network formation, each node is aware of the number of nodes that comprise the DESYNC ring 600 that it is currently part of. As a result, when a node leaves the DESYNC ring 600, as shown in FIGS. 6B and 6C, each node knows the new ATD and firing time required. When a node leaves the fully connected network, all subsequent nodes may adjust their firing times and ATDs accordingly to re-establish DESYNC. When a node that is a hidden node from the perspective of one or more nodes in the network leaves, nodes that are aware of the leaving node may increase their ATD and delay their firing so that they fire within the ATD of their preceding node. When a node's preceding heard node increases its ATD and delays its firing, the node may reduce the number of hidden-nodes it knows are between it and its preceding heard node by 1 to y, and fire at y times the new ATD from the preceding heard node.

As shown in FIG. 6B, when node D leaves the network, node C is the first to be aware of this and it changes its ATD from T/5 to T/4. Node E delays its firing as a result of this and also changes its ATD. Node A notices that node C has increased its ATD and delayed its firing time, and it now realizes that there is one less hidden node between it and node E. Thus, as shown in FIG. 6C, node A fires at a time equal to 1×T/4 and changes its ATD to T/4. Node B changes its ATD and firing time to follow the change made by node A.

In contrast to having the nodes compete for beacon transmission, the nodes belonging to an IBSS transmit the beacon in a round-robin and deterministic fashion. In each time interval, specified by the beacon period, one of the nodes in the ad hoc network is responsible for transmitting the beacon. The node that is responsible for beacon transmission on a particular beacon interval may be determined by a schedule that is maintained and broadcast at every beacon transmission. Alternatively, it may be determined by each node remembering the node previous to it in the round-robin sequence and then transmitting the beacon at the beginning of the beacon interval when its own turn to transmit the beacon has arrived, where each node need only remember the medium access control (MAC) address of the node previous to and following it in the round-robin beacon transmission sequence. When a beacon arrives at a node from the MAC address matching the one previous to it in the beacon transmission sequence, the node knows that it is the next one that transmits the beacon when it wakes up at the next beacon interval.

As in the case of the IEEE 802.11 ad hoc mode, synchronization may be achieved by each node updating its local TSF timer when the timestamp of the received beacon is faster than its own TSF timer, thus ensuring that the entire network sets their TSF timer to the TSF timer of the fastest node. In addition to this, the ATIM window may also be used to announce pending data transmissions so that nodes with pending data frames to be received may remain awake during the beacon interval. The node that transmits the beacon, the node(s) that has a pending transmission to make, and the node(s) that is scheduled to receive the pending transmission, may stay awake during the current beacon interval.

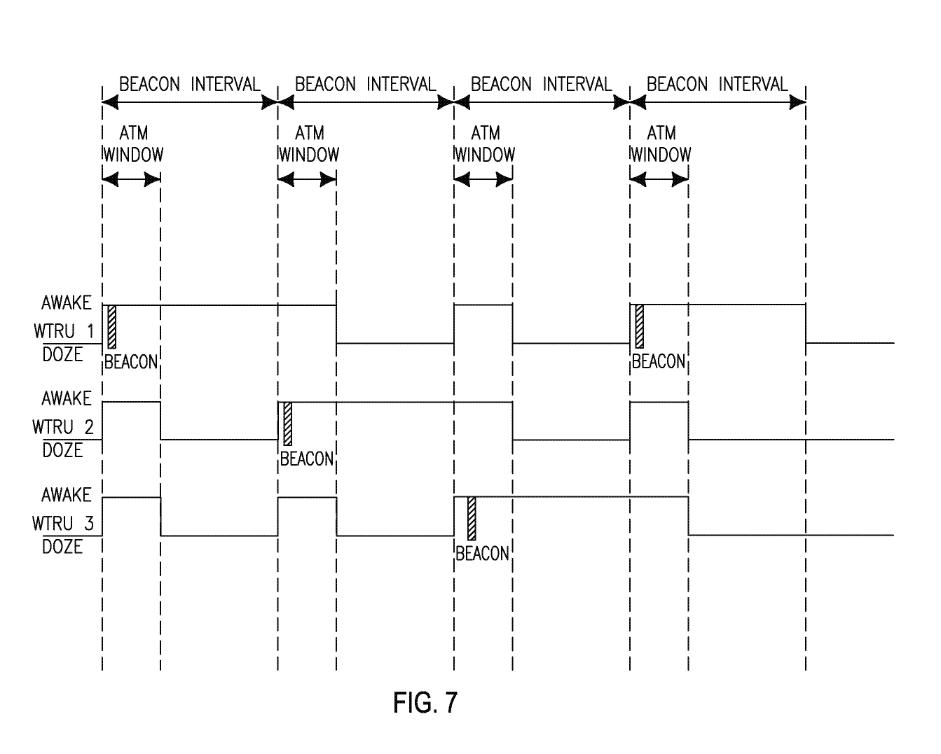

FIG. 7 shows an example of the steady-state beacon transmission between three nodes (e.g., WTRUs 1, 2 and 3) of a fully connected network, (with no data frames being transmitted over the time interval shown). When nodes are in the steady-state, each node may transmit the beacon at a regular interval that corresponds to an integer number (n) of beacon intervals following the beacon interval of the last node it may hear in a round-robin sequence. For example, when a node desires to join an IBSS, (i.e., an ad hoc network), the node may wait until it hears a beacon from a node that is already part of the IBSS. This may involve a discovery procedure where the joining node may monitor numerous known frequencies until a beacon is heard. Once a beacon is received, (e.g., from WTRU 2), the joining node may wait a random period of time, within the current beacon interval, before transmitting a join beacon frame, (a beacon frame with a special field indicating this as the desire to join the IBSS).

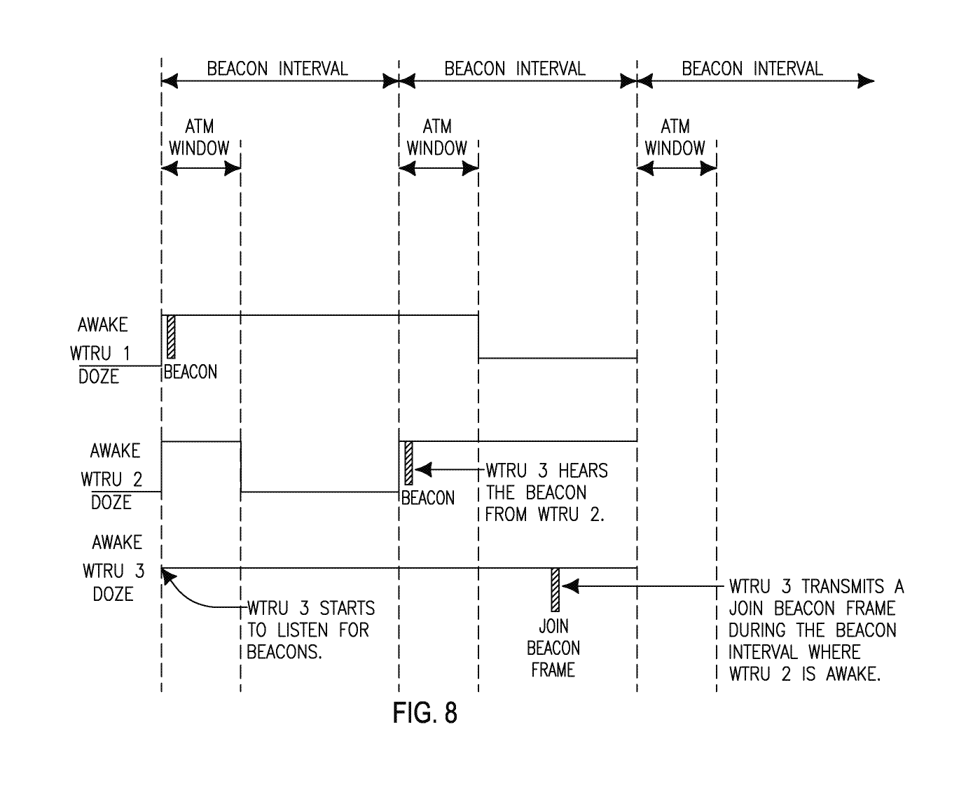

FIG. 8 shows an example of a join beacon frame transmission when a node is joining an ad hoc network. As shown in FIG. 8, since the joining node (WTRU 3) may be able to hear the beacon from WTRU 2, the WTRU 2 may also be able hear the join beacon frame. In addition, since the WTRU 2 was the last node to transmit a beacon, it may stay awake during the beacon interval and may therefore receive the join beacon frame from the joining node (i.e., the node requesting to join the IBSS). A join beacon frame may be ignored by all nodes that happen to be awake during the beacon interval, except for the node that had transmitted the beacon prior to the start of the beacon interval (in this example, WTRU 2).

Upon receiving the join beacon frame, the WTRU 2 may notify the other node(s), (i.e., WTRU 1), that a new node, (i.e., WTRU 3), is joining the round-robin sequence, and its position in the round-robin sequence resides immediately following the WTRU 2. This notification may be implemented through a broadcast message or management frame sent to all of the nodes. In addition, in a multi-hop network, this broadcast message may be forwarded by each node so that the frame reaches each of the WTRU in the ad hoc network. This message, called the station join announcement message (SJAM), may be sent during an ATIM window when all of the nodes are known to be in the awake state so that they can all receive it. In addition, depending on the size and number of hops in the network, the SJAM may be propagated through the ad hoc network over multiple ATIM windows following the transmission of the join beacon frame by the node desiring to join the network.

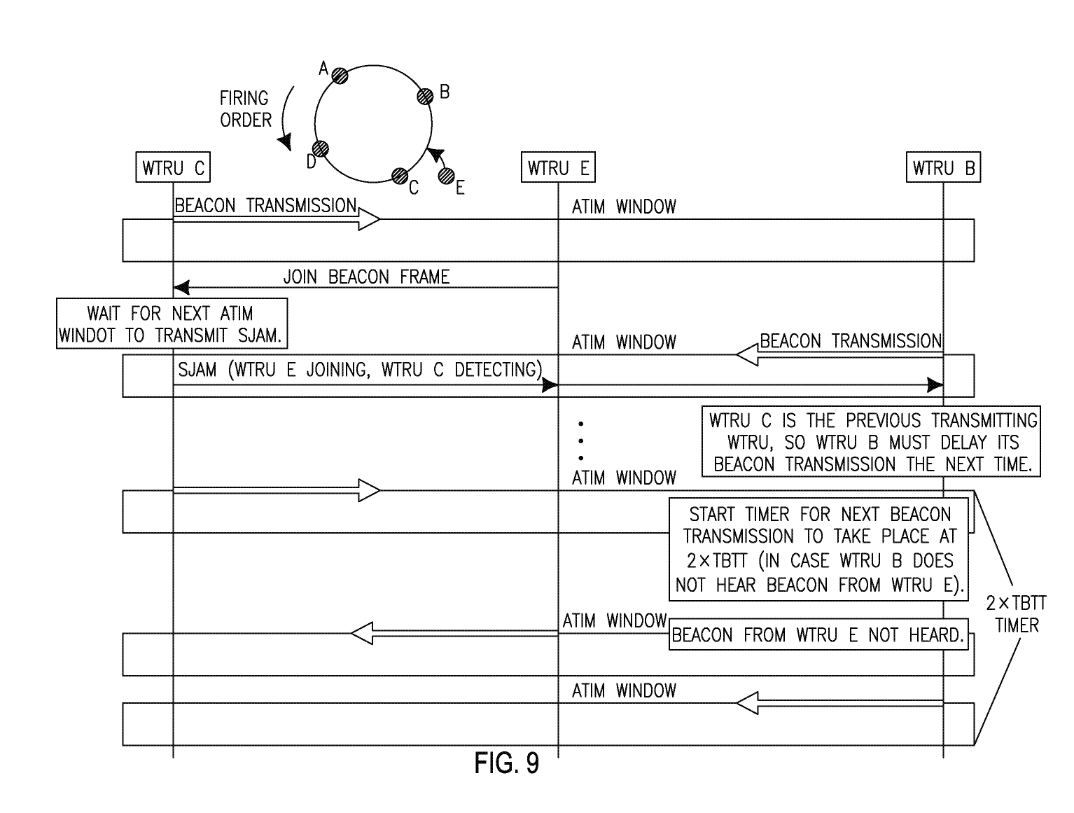

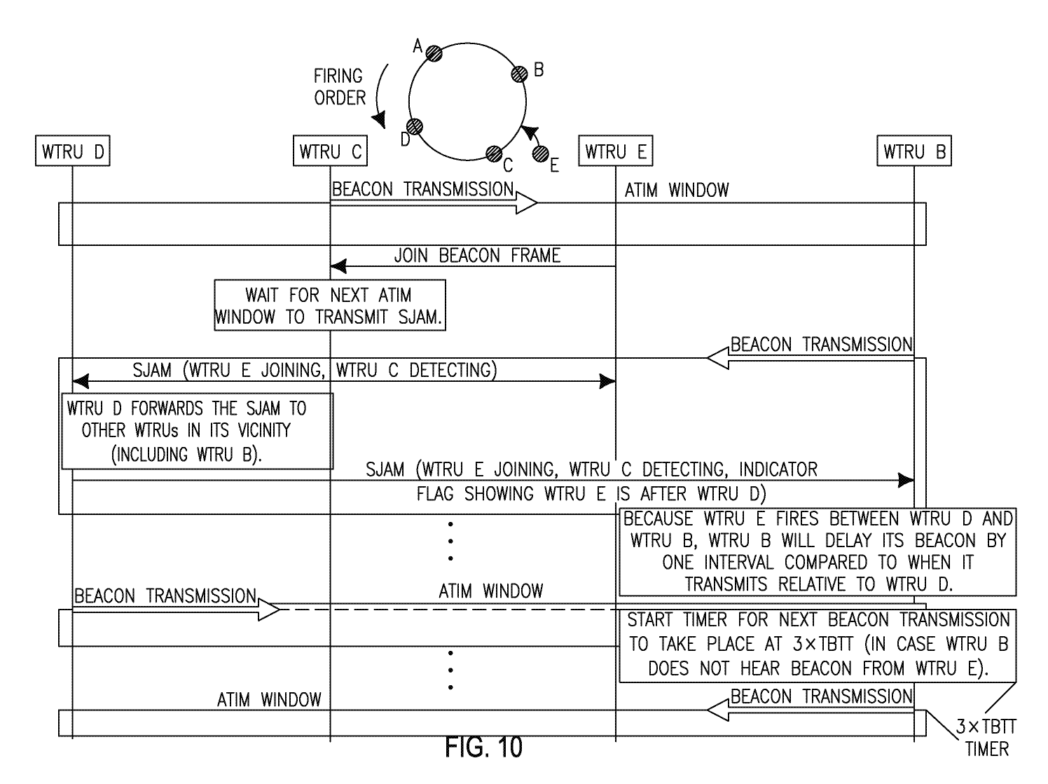

FIG. 9 shows an example of a joining procedure involved when a node joins the network, assuming that no forwarding of an SJAM is required. WTRU E wishes to join the network at the location (in the round-robin sequence) shown and transmits a join beacon frame. At the next ATIM, WTRU C transmits an SJAM indicating WTRU E as the joining node and WTRU C as the detecting node. Since WTRU C is the preceding node to WTRU B, WTRU B now delays its beacon by one TBTT interval relative to the transmission of WTRU C's beacon on a condition that the WTRU B does not hear the beacon from WTRU E. Otherwise, WTRU B may transmit its beacon following WTRU E's beacon and may add WTRU E to its partial node map.

When the SJAM is received through forwarding via another node, the node receiving the SJAM uses the value of an additional locator flag to decide whether its beacon transmission needs to be delayed. This locator flag indicates if the node that joined the network was before or after the node that is forwarding the SJAM.

FIG. 10 illustrates the joining procedure when forwarding is involved. The procedure is similar to the one shown in FIG. 9, except that WTRU B learns of WTRU E's request to join the network through WTRU D, (which forwards SJAM). WTRU D uses the indicator flag on the forwarded SJAM to determine whether its own beacon needs to be delayed.

Each node may maintain a partial node map of a round-robin sequence that is currently in the ad hoc network based on all SJAMs and station missing announcement messages (SMAMs) it receives. The partial node map may include all nodes that the particular node may hear, as well as the nodes it cannot hear that it learns of through an SJAM, (as well as the current ordering of beacon transmissions observed). The partial node map may be updated to reflect the arrival of a new joining node each time a node receives an SJAM. By default, a node may send a beacon exactly one beacon period after the node preceding it sends its beacon. In the situation where the partial node map shows that the previous node in the round-robin sequence is actually a node that is not heard by the current node, the current node may compensate by delaying its beacon transmission for an extra beacon period relative to the node it hears prior to it in the round-robin sequence. As a result, based on the location of the new joining node in the round-robin sequence, a node may behave in one of two ways when it receives an SJAM. A “previous heard node” may refer to the node that sends its beacon right before the current node, as far as what the current node may hear.

When the joining node is before the “previous heard node”, the current node may continue to send the beacon the same number of beacon intervals following the “previous heard node”. When the joining node is after the “previous heard node” but before the current node, the current node delays its beacon transmission by an extra beacon interval relative to the “previous heard node”.

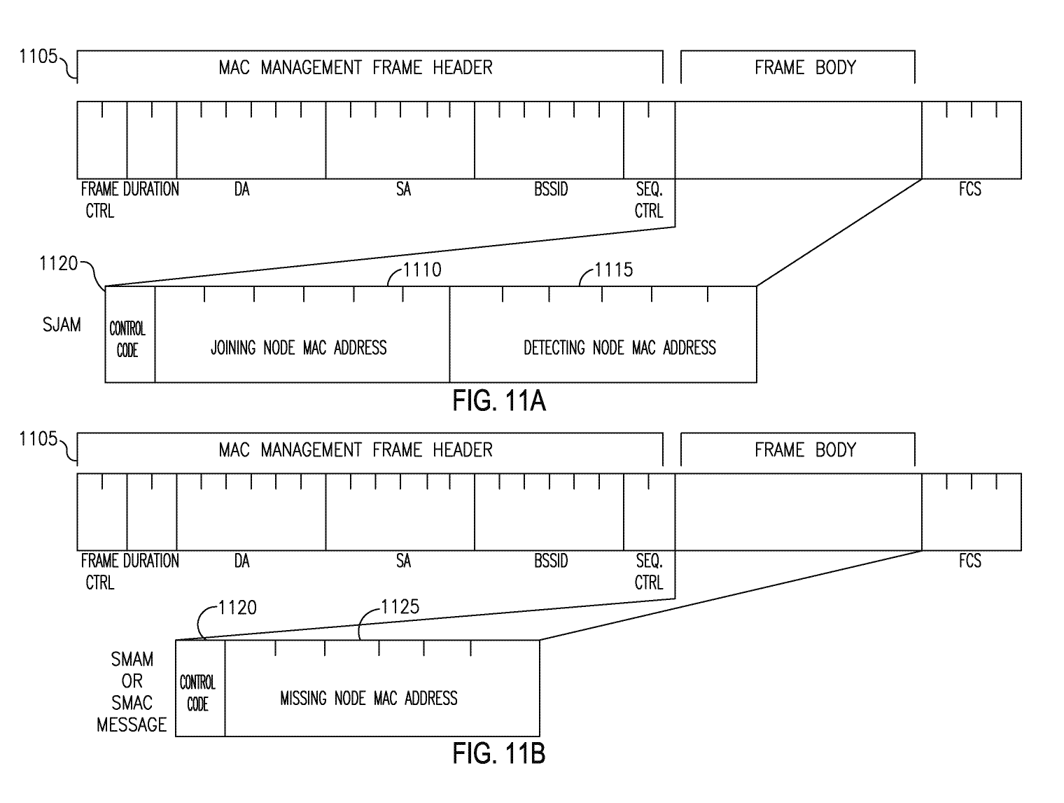

FIGS. 11A and 11B show message formats for reporting nodes joining and leaving an ad hoc network. As shown in FIG. 11A, along with a MAC management frame header 1105, an SJAM may contain in its frame body a joining node MAC address 1110 and a detecting node MAC address 1115 of the node that detected the join beacon frame transmitted by a new joining node. This information allows each node to update their partial node map and modify their beacon transmission time accordingly. A locator flag may be transmitted as part of a control code field 1120 in the message.

During the steady-state of operation, each node may utilize the partial node map that has been built up to that point. When no SJAMs are received by a particular node, the particular node may continue to send beacons at the same multiple of TBTT intervals following the “previous heard node”, (where this multiple depends on the contents of the partial node map). In the event that a node's target beacon interval arrives and the “previously heard node” did not send a beacon during the expected beacon interval, the node may transmit an SMAM that is broadcast over the entire network and sent during the ATIM window following the transmission of the beacon by the node. As shown in FIG. 11B, along with the MAC management frame header 1105, the SMAM may contain in its frame body the control code field 1120 and a missing node MAC frame 1125.

Following transmission of an SMAM, any node that is still able to hear beacons from the presumably missing node may reply to the SMAM within a predetermined time period (e.g., a predetermined number of beacon intervals). If no response to an SMAM is received within the predetermined time period, the node may assume that the presumably missing node has left the network, and may modifies it node map accordingly. The node may then broadcast a station missing announcement confirm (SMAC) message to confirm that the presumably missing node left the network, as shown in FIG. 11B. Reception of an SMAC message by a node also updates its node map, as with the SJAM. The SMAC message may also be transmitted over the ATIM window so that all nodes may successfully receive it.

DESYNC may be applied to cellular systems. In general, WTRUs in a cellular system obtain their timing and frequency synchronization through a synchronization channel transmitted by the base station. For example, in LTE, a primary synchronization sequence (PSS) and a secondary synchronization sequence (SSS) may be transmitted by a base station to allow the WTRUs to synchronize their timing and frequency to a common reference.

Alternatively, a WTRU may choose to communicate directly with another WTRU and, in doing so, may move to a state where it ignores the synchronization from the base station. For instance, WTRU-to-WTRU communication may take place on a different frequency than the communication with the base station. In such a scenario, WTRUs involved in WTRU-to-WTRU communication may synchronize to each other's timing and frequency to allow for communication.

In the scenario of WTRU-to-WTRU communication, each WTRU may independently transmit information including a PSS and an SSS in a specific frame. The PSS and SSS transmitted by a specific WTRU may represent its own timing and frequency information. In addition, certain rules may be followed for when a WTRU adjusts its own frequency and timing based on the received PSS and SSS. For example, a WTRU may chose to change its frequency to the frequency advertised by the PSS/SSS, or may ignore it and transmit a PSS/SSS based on its own oscillator frequency, depending on the rules defined.

In order to apply DESYNC to such a cellular system, each node may transmit a PSS and SSS in a specific frame based on a round-robin scheduling. When a WTRU wishes to join a WTRU-to-WTRU network, it may transmit a join beacon frame or request during the frame time which follows the PSS/SSS of a WTRU in the network it hears. Since an LTE 10 ms frame time may be maintained, a WTRU may know the time interval in which it may transmit the PSS/SSS. The join beacon frame may take the form of an LTE random access channel (RACH) preamble transmitted by the node that desires to join the WTRU-to-WTRU network. This RACH preamble may be transmitted by a WTRU on certain defined subframe(s) following each PSS/SSS. The WTRU which sent the PSS/SSS immediately prior to the join beacon frame or request may then broadcast an SJAM through a physical downlink control channel (PDCCH), or using a data message that is addressed by a common search space. As in the case of IEEE 802.11 ad hoc, the schedule of each WTRU's transmission of PSS/SSS may then be tailored.

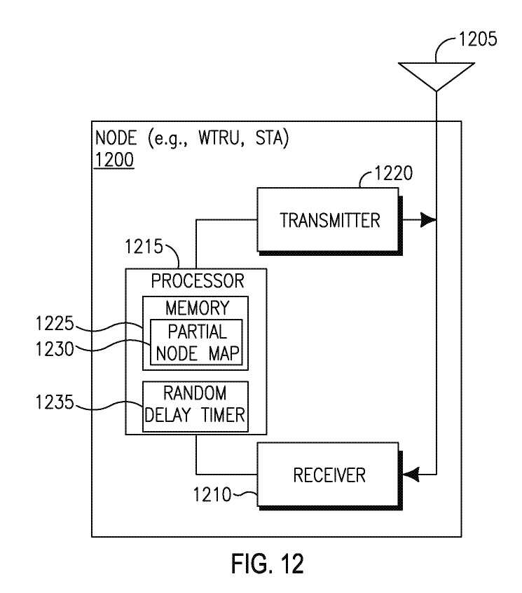

FIG. 12 shows an example block diagram of a node 1200 including at least one antenna 1205, a receiver 1210, a processor 1215 and a transmitter 1220. The processor 1215 may include a memory 1225 having a partial node map 1230 stored therein, and a random delay timer 1235. Alternatively, one or both of the memory 1225 and the random delay timer 1235 may reside outside of the processor 1215.

The receiver 1210 may be configured to receive a beacon from a specific one of a plurality of existing nodes in a network during a beacon interval. The random delay timer 1235 may be configured to be activated for a random period of time in response to the receiver 1210 receiving the beacon. The transmitter 1220 may be configured to transmit a join beacon frame during the beacon interval after the random delay timer 1235 expires.

The partial node map 1230 stored in the memory 1225 of the processor 1215 may indicate all nodes in the network that the node 1200 detects and cannot detect, and an order of a round-robin sequence of beacon transmissions that is currently being implemented in the network.

The transmitter 1220 may be further configured to transmit a notification to nodes in the network indicating that a new node is joining the network, transmit a first message indicating that a particular one of the nodes may have left the network, and transmit a second message confirming that the particular node left the network on a condition that the node 1200 did not receive a response to the first message within a predetermined period of time.

The transmitter 1220 may be configured to transmit beacon and synchronization information in accordance with a round-robin scheduling sequence. The information may indicate an advertised time difference between transmission events of two of the existing nodes.

The receiver 1210 may be configured to receive information from a specific one of the existing nodes and join the network. The transmitter 1220 may be further configured to generate a transmission event based on one half of the advertised time difference.

The transmitter 1220 may be configured to transmit a PSS and an SSS in accordance with a round-robin scheduling sequence. The receiver 1210 may be configured to receive a PSS and an SSS from a specific one of the existing nodes during a beacon interval. The transmitter 1220 may be further to generate a RACH preamble during the beacon interval indicating that it desires to join the network.

Although features and elements are described above in particular combinations, one of ordinary skill in the art will appreciate that each feature or element may be used alone or in combination with any of the other features and elements. In addition, the embodiments described herein may be implemented in a computer program, software, or firmware incorporated in a computer-readable medium for execution by a computer or processor. Examples of computer-readable media include electronic signals, (transmitted over wired or wireless connections), and computer-readable storage media. Examples of computer-readable storage media include, but are not limited to, a read only memory (ROM), a random access memory (RAM), a register, a cache memory, a semiconductor memory device, a magnetic media, (e.g., an internal hard disc or a removable disc), a magneto-optical media, and an optical media such as a compact disc (CD) or a digital versatile disc (DVD). A processor in association with software may be used to implement a radio frequency transceiver for use in a WTRU, UE, terminal, base station, Node-B, eNB, HNB, HeNB, AP, RNC, wireless router or any host computer.

What is claimed is:

1. A method of synchronizing a network, the method comprising:
a plurality of existing nodes in the network transmitting beacons in accordance with a round-robin scheduling sequence;
a new joining node receiving a beacon from a specific one of the existing nodes during a beacon interval;
the new joining node transmitting a join beacon frame during the beacon interval after waiting a random period of time; and
the specific existing node receiving the join beacon frame and transmitting a notification to the other existing nodes in the network indicating that a new node is joining the network.

2. The method of claim 1 wherein the notification is a broadcast message or a management frame.

3. The method of claim 1 wherein the notification is transmitted during an announcement traffic indication message (ATIM) window while the existing nodes in the network are activated.

4. The method of claim 1 wherein each of the existing nodes transmit a beacon during an announcement traffic indication message (ATIM) window while the existing nodes are activated.

5. The method of claim 1 wherein the notification is a message including a medium access control (MAC) management frame header and a frame body having a joining node MAC address and a detecting node MAC address.

6. The method of claim 1 further comprising:
the existing nodes adjusting the delay between their beacon transmissions to accommodate the joining node based on information in the notification.

7. The method of claim 1 wherein the notification is a message including a frame body having a control code field with a locator flag that is set by the specific existing node.

8. The method of claim 1 further comprising:
each particular one of the nodes maintaining a partial node map indicating all nodes in the network that the particular node detects and cannot detect, and an order of a round-robin sequence of beacon transmissions that is currently being implemented in the network.

9. The method of claim 8 further comprising:
updating the partial node map to reflect the arrival of the new joining node based on information in the notification.

10. The method of claim 9 wherein each of the nodes transmits a beacon during a respective beacon interval in the round-robin sequence at a multiple of a target beacon transmission time (TBTT) interval to avoid beacon collision with the other nodes in the network.

11. The method of claim 1 wherein the nodes are wireless transmit/receive units (WTRUs).

12. The method of claim 1 wherein each of the nodes is configured to transmit a first message indicating that a particular one of the nodes may have left the network and wait for a response to the first message.

13. The method of claim 12 wherein each node that transmitted the first message is further configured to transmit a second message confirming that the particular node left the network on a condition that the node that transmitted the first message did not receive a response to the first message within a predetermined period of time.

14. A method of synchronizing a network, the method comprising:
a plurality of existing nodes in the network transmitting information in accordance with a round-robin scheduling sequence, the information indicating an advertised time difference between transmission events of two of the existing nodes;
a new node receiving information from a specific one of the existing nodes and joining the network; and
the new joining node generating a transmission event based on one half of the advertised time difference.

15. The method of claim 14 wherein the information further includes a hop number and a network identity (ID) used to coordinate a maximum number of nodes that form the network.

16. The method of claim 14 wherein the information transmitted by all of the existing nodes and the new joining node is adjusted to indicate the same advertised time difference.

17. A method of synchronizing a network, the method comprising:
each of a plurality of existing nodes in the network transmitting a primary synchronization sequence (PSS) and a secondary synchronization sequence (SSS) in accordance with a round-robin scheduling sequence;
a new node receiving the PSS and SSS from a specific one of the existing nodes; and
the new node generating a random access channel (RACH) preamble indicating that it desires to join the network.

18. A wireless transmit/receive unit (WTRU) comprising:
a receiver configured to receive a beacon from a specific one of a plurality of existing nodes in a network during a beacon interval;
a random delay timer configured to be activated for a random period of time in response to the receiver receiving the beacon; and
a transmitter configured to transmit a join beacon frame during the beacon interval after the random delay timer expires.

19. The WTRU of claim 18 wherein the WTRU further comprises a memory configured to store a partial node map indicating all nodes in the network that the WTRU detects and cannot detect, and an order of a round-robin sequence of beacon transmissions that is currently being implemented in the network.

20. A wireless transmit/receive unit (WTRU) comprising:
a receiver configured to receive a primary synchronization sequence (PSS) and a secondary synchronization sequence (SSS) from a specific one of a plurality of existing nodes in a network during a beacon interval; and
a transmitter configured to transmit a random access channel (RACH) preamble during the beacon interval indicating that it desires to join the network.
